(19) United States
(12) Patent Application Publication
(10) Pub. No.: US 2026/0184082 A1
(43) Pub. Date: Jul. 2, 2026

(54) LIQUID CONTAINER INCLUDING BLOW-MOLDED HOUSING HAVING FIRST WALL, SECOND WALL, LIQUID CHAMBER, AND SUPPLY PORTION

(71) Applicant: BROTHER KOGYO KABUSHIKI KAISHA, Nagoya (JP)

(72) Inventors: Masahiro HAYASHI, Anjo (JP); Hiroaki TAKAHASHI, Nagoya (JP); Satoru OKI, Nagoya (JP); Fumiya NAKAMURA, Nagoya (JP); Naoya OKAZAKI, Hashima (JP)

(73) Assignee: BROTHER KOGYO KABUSHIKI KAISHA, Nagoya (JP)

(21) Appl. No.: 19/405,601

(22) Filed: Dec. 2, 2025

(30) Foreign Application Priority Data
Dec. 27, 2024 (JP) 2024-231503

(51) Int. Cl. B41J 2/175

(52) U.S. Cl. CPC B41J 2/17553; B41J 2/17559; B41J 2/17596

(57) ABSTRACT

A liquid container includes a blow-molded housing having a parting line. The blow-molded housing includes: a first wall; a second wall; a liquid chamber; and a supply portion. The second wall opposes the first wall in a left-right direction. The liquid chamber is positioned between the first wall and the second wall. An inside of the liquid chamber is in communication with an outside of the liquid chamber through the supply portion. In the liquid container: the parting line has a portion positioned at the supply portion; and a distance between the first wall and the portion of the parting line in the left-right direction is greater than a distance between the second wall and the portion of the parting line in the left-right direction.

### REFERENCE TO RELATED APPLICATIONS

This application claims priority from Japanese Patent Application No. 2024-231503 filed on Dec. 27, 2024. The entire content of the priority application is incorporated herein by reference.

### BACKGROUND ART

A known ink cartridge includes an ink storage chamber for storing ink in the ink storage chamber. The ink cartridge further includes a case for covering the ink storage chamber, which stores ink. The case includes a first case member and a second case member. The case is manufactured using two first case members having different thicknesses and two second case members having different thicknesses. The manufactured case has three types in which external sizes are different.

### SUMMARY

In the known ink cartridge, the first case member is joined to the second case member which has a thickness different from that of the first case member. Hence, a cartridge having a desired volume is manufactured by changing the combination of the first case members and the second case members.

The case is made of resin material. The first case members and the second case members are formed by injection-molding. The ink cartridge is manufactured by joining the molded first case member and the molded second case member. Accordingly, the manufacturing of the ink cartridge requires a large number of process steps. In addition, the costs of mold are likely to be high in injection-molding.

In view of the foregoing, it is an object of the present disclosure to reduce the manufacturing costs of a liquid container having an asymmetrical shape.

In order to attain the above and other objects, the present disclosure provides a liquid container including a blow-molded housing having a parting line. The blow-molded housing includes: a first wall; a second wall; a liquid chamber; and a supply portion. The second wall opposes the first wall in a left-right direction. The liquid chamber is positioned between the first wall and the second wall. An inside of the liquid chamber is in communication with an outside of the liquid chamber through the supply portion. In the liquid container: the parting line has a portion positioned at the supply portion; and a distance between the first wall and the portion of the parting line in the left-right direction is greater than a distance between the second wall and the portion of the parting line in the left-right direction.

In the above structure, the number of steps and the costs of mold required to manufacture a liquid container which has an asymmetrical shape can be reduced.

### BRIEF DESCRIPTION OF DRAWINGS

FIG. 1 is a vertical sectional view schematically illustrating the internal structure of a printer 10.

FIG. 2 is an enlarged vertical sectional view of an ink cartridge 30 attached to a cartridge case 110 illustrated in FIG. 1.

FIG. 3 is a left rear upper perspective view of the ink cartridge 30.

FIG. 4 is a right front bottom perspective view of the ink cartridge 30.

FIG. 5 is a left front upper perspective view of the ink cartridge 30.

FIG. 6A is a vertical sectional view schematically illustrating a parison 211 before blow-molding.

FIG. 6B is a vertical sectional view schematically illustrating the parison 211 clamped by molds 213 during the insertion of a blow pin 212.

FIG. 6C is a vertical sectional view schematically illustrating the parison 211 clamped by the molds 213 in a state where the insertion of the blow pin 212 is completed.

FIG. 7A is a plan view of the ink cartridge 30 from above.

FIG. 7B is a plan view of the ink cartridge 30 from the rear.

FIG. 8A is a plan view of an ink cartridge 30 from above.

FIG. 8B is a plan view of the ink cartridge 30 from the rear.

FIG. 9A is a top sectional view of a main body 31 in which a parting line 717 is positioned on a virtual surface 707 at a rear wall 41, during the blow-molding of the main body 31.

FIG. 9B is a top sectional view of the main body 31 in which a parting line 719 is positioned further leftward than the virtual surface 707 at the rear wall 41, during the blow-molding of the main body 31.

FIG. 10 is a left rear upper perspective view of an ink cartridge 1030.

FIG. 11 is a right front bottom perspective view of the ink cartridge 1030.

FIG. 12A is a perspective view schematically illustrating a printer 1010 in which a case cover 1730 closes an opening 1112.

FIG. 12B is a perspective view schematically illustrating the printer 1010 in which the case cover 1730 opens the opening 1112.

FIG. 13 is a left rear upper perspective view of an ink cartridge 2030.

FIG. 14A is a perspective view schematically illustrating the printer 1010 in which a case cover 1731 closes the opening 1112.

FIG. 14B is a perspective view schematically illustrating the printer 1010 in which the case cover 1731 opens the opening 1112.

### DESCRIPTION

Hereinafter, one embodiment of the present disclosure will be described while referring to the accompanying drawings. It should be understood that the following embodiment is merely an example of the disclosure, and that this embodiment may be modified as appropriate without departing from the spirit of the disclosure.

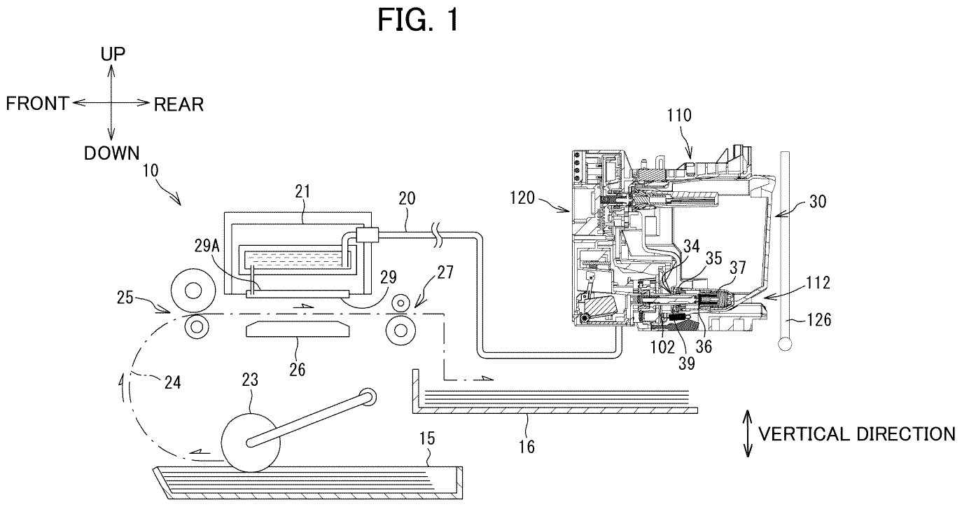

In the following description, a direction in which an ink cartridge 30 is attached to and detached from a cartridge case 110 of a printer 10 will be defined as the front-rear direction. In the front-rear direction, the ink cartridge 30 is attached to the cartridge case 110 in the frontward direction and the ink cartridge 30 is detached from the cartridge case 110 in the rearward direction. The vertical direction illustrated in FIG. 1 will be defined as the up-down direction. A direction orthogonal to both the front-rear direction and the up-down direction will be defined as the left-right direction.

In the left-right direction, the right and the left are defined based on the perspective of the user viewing from the front toward the rear. In this description, components constituting the ink cartridge 30 face in specific directions. However, the directions in which the components face are not limited to only the specific directions. For example, even though a front surface of the ink cartridge 30 faces in the frontward direction in the following description, the front surface may face frontward and upward.

Further, for each component in the printer 10 and the ink cartridge 30, the center of the component in the left-right direction will be simply referred to as the “left-right center of the component”. The same applies to the up-down direction and the front-rear direction.

### First Embodiment

As illustrated in FIG. 1, the printer 10 includes the cartridge case 110, a sub tank 120, an ink tube 20, a recording head 21, and the ink cartridge 30. The ink cartridge 30 is an example of the liquid container. The cartridge case 110 is an example of the cartridge attachment portion. The printer 10 is an inkjet recording apparatus which is configured to record images through the ejection of ink droplets from the recording head 21 onto sheets according to an inkjet recording method. The printer 10 is an example of the image forming apparatus.

The printer 10 includes the cartridge case 110. The ink cartridge 30 is attachable to and detachable from the cartridge case 110. In a state where the ink cartridge 30 is attached to the cartridge case 110, an ink supply tube 102 is inserted into a supply portion 33 of the ink cartridge 30. Hence, ink can be supplied from the ink cartridge 30 to the recording head 21 through the ink supply tube 102 and the ink tube 20.

The cartridge case 110 includes an opening 112 at the rear end portion of the cartridge case 110. The ink cartridge 30 is configured to be attached to the cartridge case 110 in the frontward direction through the opening 112. The ink cartridge 30 is configured to be detached from the cartridge case 110 in the rearward direction through the opening 112. A case cover 126 is configured to open and close the opening 112. FIG. 1 illustrates an attachment state where the attachment of the ink cartridge 30 to the cartridge case 110 is completed.

The ink cartridge 30 stores ink which can be used in the printer 10 in the ink cartridge 30. Ink may be a liquid containing colorants such as pigments, or may be a treatment liquid containing additives for improving image quality in place of colorants. In a state where the ink cartridge 30 is attached to the cartridge case 110, the ink cartridge 30 and the recording head 21 are connected to each other via the ink tube 20. The recording head 21 is configured to eject ink supplied from the ink cartridge 30 through a plurality of nozzles 29. Specifically, a head control board provided in the recording head 21 selectively applies driving voltage to a plurality of piezoelectric elements 29A corresponding to the plurality of nozzles 29.

Since the driving voltage are selectively applied, ink is selectively ejected from the nozzles. That is, the recording head 21 is configured to consume ink stored in the ink cartridge 30 which is attached to the cartridge case 110.

The printer 10 includes a sheet feed tray 15, a sheet feed roller 23, a pair of conveying rollers 25, a platen 26, a pair of discharge rollers 27, and a sheet discharge tray 16. The sheet feed roller 23 feeds sheets on the sheet feed tray 15 toward a conveying path 24. The sheet fed to the conveying path 24 reaches the pair of conveying rollers 25. The pair of conveying rollers 25 conveys the sheet which has reached the pair of conveying rollers 25 onto the platen 26. The recording head 21 selectively ejects ink onto the sheet passing over the platen 26.

In this way, an image is recorded on the sheet. The sheet which has passed over the platen 26 reaches the pair of discharge rollers 27. The pair of discharge rollers 27 discharges the sheet which has reached the pair of discharge rollers 27 onto the sheet discharge tray 16 which is at the most downstream end of the conveying path 24.

### <Ink Cartridge 30>

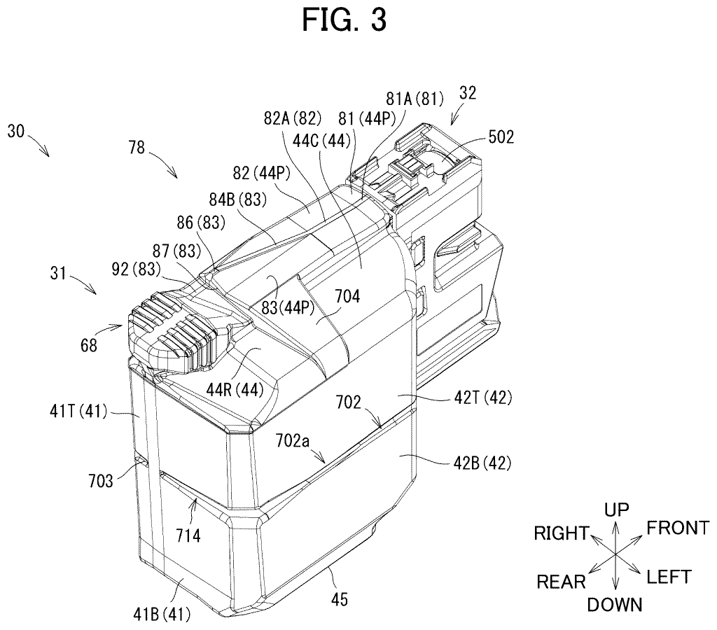

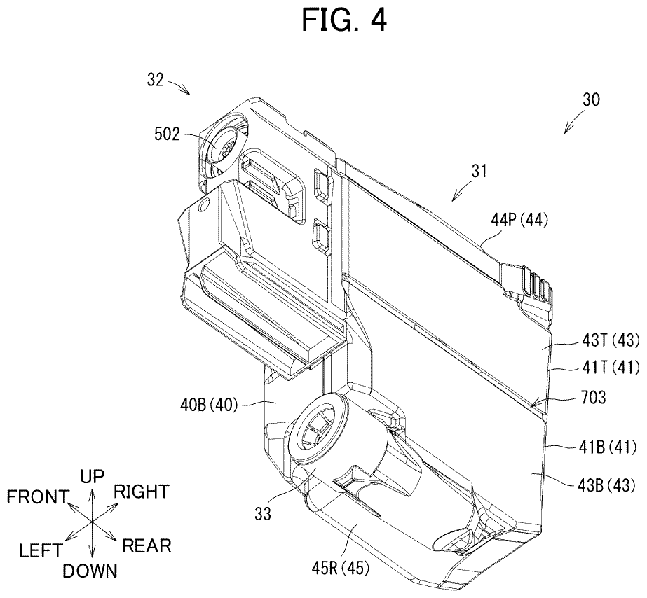

The ink cartridge 30 is a container configured to store ink, which is liquid. As illustrated in FIGS. 3 and 4, the ink cartridge 30 includes a main body 31 and a cover 32. The main body 31 is a blow-molded product (blow-molded member) made of synthetic resin, for example. The main body 31 is an example of a blow-molded housing.

The cover 32 is mounted to the front portion of the main body 31. The cover 32 has a rectangular parallelepiped shape. The length of the cover 32 in the up-down direction is shorter than the length of the main body 31 in the up-down direction. Also, the length of the cover 32 in the front-rear direction is shorter than the length of the main body 31 in the front-rear direction. The cover 32 has a box shape and includes an opening facing rearward. The ink cartridge 30 is attached to the cartridge case 110 in the frontward direction with the cover 32 facing toward the cartridge case 110.

The main body 31 has a flattened rectangular parallelepiped shape in which the length of the main body 31 in the left-right direction is smaller than the lengths of the main body 31 in both the up-down direction and the front-rear direction. The main body 31 includes a front wall 40, a rear wall 41, a left wall 42, a right wall 43, an upper wall 44, a bottom wall 45, a storage chamber 46, the supply portion 33, an atmospheric passage portion 502 and a sloped wall 716. The left wall 42 and the right wall 43 are examples of the first wall. The left wall 42 and the right wall 43 are examples of the second wall. The storage chamber 46 is an example of the liquid chamber.

The front wall 40, the rear wall 41, the left wall 42, the right wall 43, the upper wall 44, and the bottom wall 45, and the sloped wall 716 define the storage chamber 46, which is an inside space of the main body 31. Each of the front wall 40, the rear wall 41, the left wall 42, the right wall 43, the upper wall 44, and the bottom wall 45, and the sloped wall 716 has translucency such that the level of ink inside the storage chamber 46 can be seen from outside. The inside and the outside of the storage chamber 46 are in communication with each other through both the supply portion 33 and the atmospheric passage portion 502.

The outer surface of the front wall 40 faces in the frontward direction. The rear wall 41 faces the front wall 40 in the front-rear direction. In other words, the rear wall 41 is opposed to the front wall 40 in the front-rear direction. The right wall 43 connects the front wall 40 and the rear wall 41. The left wall 42 faces the right wall 43 in the left-right direction. In other words, the left wall 42 is opposed to the right wall 43 in the left-right direction. The sloped wall 716 is connected to the left wall 42.

The upper wall 44 connects the front wall 40 and the rear wall 41. The bottom wall 45 faces the upper wall 44 in the up-down direction. In other words, the bottom wall 45 is opposed to the upper wall 44 in the up-down direction.

As illustrated in FIGS. 4, 5, and 7A, the front wall 40 includes an upper front wall 40T and a lower front wall 40B. The upper front wall 40T is the upper portion of the front wall 40. The lower front wall 40B is the lower portion of the front wall 40. The lower front wall 40B is positioned further downward than the upper front wall 40T. The upper front wall 40T is positioned further frontward than the lower front wall 40B. The space positioned further rearward than the upper front wall 40T is part of the storage chamber 46. The upper portion of the storage chamber 46 extends further frontward than the lower portion of the storage chamber 46.

The upper front wall 40T has the atmospheric passage portion 502 having a cylindrical shape. The vicinity of the upper portion of the storage chamber 46 and the outside of the storage chamber 46 are in communication with each other through the atmospheric passage portion 502. In other words, the atmospheric passage portion 502 provides communication between the inside and the outside of the storage chamber 46. The lower front wall 40B is continuous with the supply portion 33. The supply portion 33 is positioned further downward than the atmospheric passage portion 502.

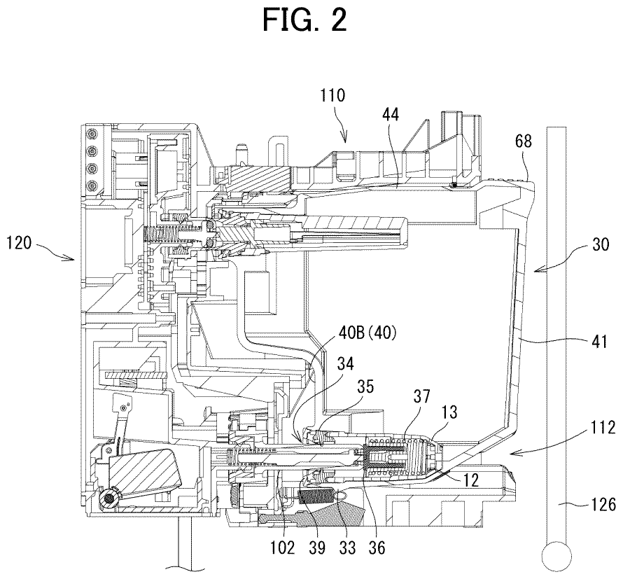

As illustrated in FIG. 2, a lower support member 13 is provided in the internal space of the supply portion 33. The lower support member 13 has a cylindrical shape extending in the front-rear direction. At least part of a lower valve mechanism 12 is provided in the internal space of the lower support member 13. The lower valve mechanism 12 includes a sealing member 35, a valve 36, a coil spring 37, and a cap 39. The inner shape of the lower support member 13 corresponds to the outer shape of the lower valve mechanism 12.

The outer shape of the lower valve mechanism 12 has a cylindrical shape. The sealing member 35 is a circular member which is made of elastic material, such as rubber. The sealing member 35 has a cylindrical through hole extending in the front-rear direction. The sealing member 35 is positioned in the internal space of the supply portion 33. The sealing member 35 is in tight contact with the inner circumferential surface of the supply portion 33 at a position slightly rearward than a supply opening 34.

The valve 36 is positioned in the internal space of the lower support member 13. That is, the supply portion 33 accommodates the valve 36 in the supply portion 33. The valve 36 is movable in the front-rear direction in the internal space of the lower support member 13. Since the valve 36 is in contact with the sealing member 35, the supply opening 34 is sealed.

The coil spring 37 urges the valve 36 to the sealing member 35. The cap 39 is mounted to the inner surface of the supply portion 33 around the supply opening 34. The cap 39 is adhered to the inner surface of the lower support member 13 with an adhesive. The cap 39 may be fixed to the inner surface of the lower support member 13 by welding.

The cap 39 has a circular truncated cone shape. The cap 39 has a through hole extending in the front-rear direction. The ink supply tube 102 of the cartridge case 110 is configured to be inserted into the through hole of the cap 39. The ink supply tube 102 is configured to press the valve 36 rearward against the urging force of the coil spring 37. The valve 36 moves rearward from a closing position to an opening position due to the pressure of the ink supply tube 102.

When the valve 36 is at the opening position, the internal space of the lower support member 13 and the internal space of a supply tube 104 are in communication with each other. As a result, ink in the storage chamber 46 flows into the internal space of the ink supply tube 102 through the internal space of the lower support member 13. The sealing member 35 is configured to be in liquid-tight contact with the outer surface of the ink supply tube 102. That is, the sealing member 35 is in liquid-tight contact with the outer surface of the ink supply tube 102 in a state where the ink supply tube 102 is inserted into the internal space of the supply portion 33.

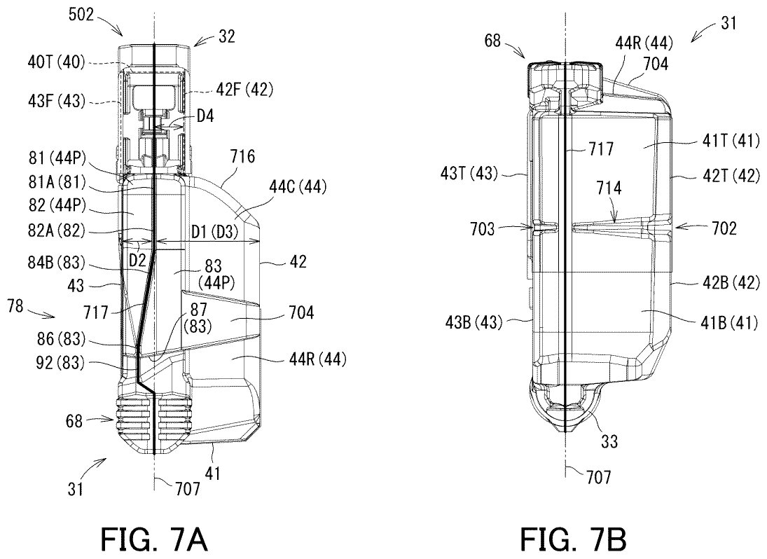

As illustrated in FIGS. 3 and 7A, the rear wall 41 includes an upper rear wall 41T and a lower rear wall 41B. The upper rear wall 41T is positioned further upward than the lower rear wall 41B. A rear lib 714 is positioned between the upper rear wall 41T and the lower rear wall 41B. The upper rear wall 41T is connected to the upper wall 44. The lower rear wall 41B is connected to the bottom wall 45.

As illustrated in FIGS. 3, 5, and 7A, the left wall 42 includes a front left wall 42F, an upper left wall 42T, and a lower left wall 42B. The front left wall 42F is positioned further frontward than the upper left wall 42T in the front-rear direction. The upper left wall 42T is positioned further upward than the lower left wall 42B. A left lib 702 is positioned between the upper left wall 42T and the lower left wall 42B. The upper end of the upper left wall 42T is connected to the upper wall 44. The front end of the upper left wall 42T is connected to an upper sloped wall 716T.

The lower end of the lower left wall 42B is connected to the bottom wall 45. The front end of the lower left wall 42B is connected to a lower sloped wall 716B. The outer surface of the upper left wall 42T and the outer surface of the lower left wall 42B are flush with each other.

As illustrated in FIGS. 4 and 7A, the right wall 43 includes a front right wall 43F, an upper right wall 43T, and a lower right wall 43B. The upper right wall 43T is positioned further upward than the lower right wall 43B. A right lib 703 is positioned between the upper right wall 43T and the lower right wall 43B. The upper right wall 43T is connected to the upper wall 44. The lower right wall 43B is connected to the bottom wall 45.

The outer surface of the upper right wall 43T and the outer surface of the lower right wall 43B are flush with each other.

As illustrated in FIG. 3, the upper wall 44 includes a rear upper wall 44R, a central upper wall 44C, a protruding upper wall 44P and a front upper wall. The front upper wall is positioned further frontward than the protruding upper wall 44P in the front-rear direction, although covered by the cover 32 and thus not shown in FIG. 3. The rear upper wall 44R is the left-rear portion of the upper wall 44. The central upper wall 44C is positioned between the front upper wall and the rear upper wall 44R in the front-rear direction. The protruding upper wall 44P is positioned further rightward than both the rear upper wall 44R and the central upper wall 44C.

As illustrated in FIGS. 3 through 5, the protruding upper wall 44P has a first upper surface 81, a second upper surface 82, a third upper surface 83, an operation surface 68 which are arranged in this order from the front. The first upper surface 81 has a surface 81A positioned at the left-right center of the first upper surface 81. The surface 81A is a flat surface orthogonal to the up-down direction and extending in the front-rear direction. The surface 81A is positioned further upward than the other portions of the first upper surface 81 other than the surface 81A.

The second upper surface 82 is continuous with the rear end of the first upper surface 81. The second upper surface 82 has a surface 82A positioned at the left-right center of the second upper surface 82. The surface 82A is a flat surface extending in the front-rear direction. The surface 82A is also sloped relative to the front-rear direction so as to face upward and frontward. The surface 82A is positioned further upward than the other portions of the second upper surface 82 other than the surface 82A. The surface 82A is continuous with the rear end of the surface 81A.

As illustrated in FIG. 7A, the axis of the atmospheric passage portion 502 and the axis of the supply portion 33 overlap each other when viewed from above (i.e., when viewed in the up-down direction). Hereinafter, a flat surface having both the axis of the atmospheric passage portion 502 and the axis of the supply portion 33, and being orthogonal to the left-right direction will be referred to as a virtual surface 707. The main body 31 has a parting line 717 overlapping the virtual surface 707 at the supply portion 33. Parting line is a flash that is formed on a product produced through casting, injection-molding, blow-molding, or the like. A portion of the main body 31 from which the flash has been removed (trimmed off) is also referred to as the parting line. The parting line 717 is located at the mating joint of two molds that clamps (or enclose) a parison from opposite sides in the left-right direction during blow-molding for producing the main body 31. Since the two molds are separated from each other in the left-right direction after the blow-molding, the parting line 717 passes through the portion of the parison which protrudes most outward in both the up-down direction and the front-rear direction (i.e., the parting line 717 extends along the position of the flash of the parison which protrudes most outward in both the up-down direction and the front-rear direction).

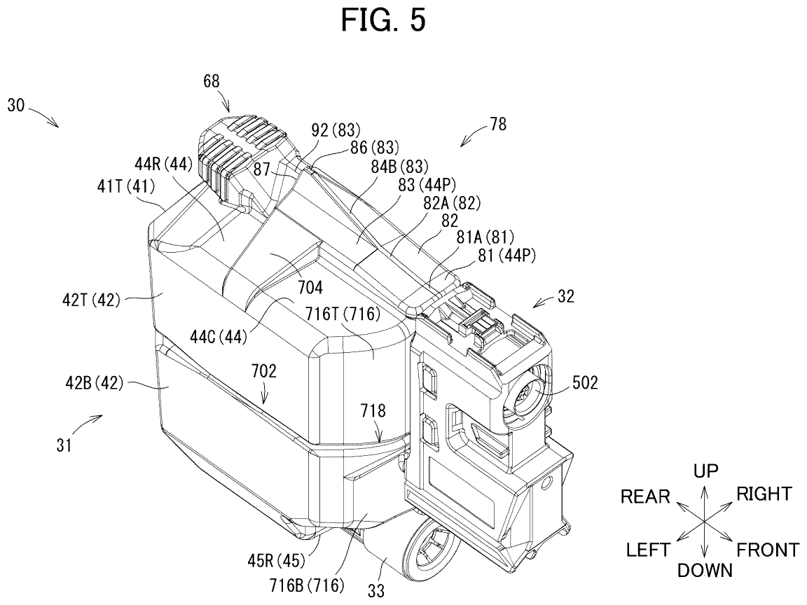

As illustrated in FIGS. 3 and 5, the third upper surface 83 is continuous with the rear end of the second upper surface 82. The third upper surface 83 has a key portion 78 and a contact surface 92. The key portion 78 is an example of the lock portion. As illustrated in FIG. 7A, the key portion 78 is positioned closer to the right wall 43 than the virtual surface 707 is to the right wall 43.

The mechanical characteristics of the key portion 78, such as arrangements and shapes, are different depending on the characteristics of ink cartridges (including the ink cartridge 30). When an ink cartridge is attached to the cartridge case 110 of the printer 10, the key portion 78 comes into engagement with the cartridge case 110, and the cartridge case 110 detects the mechanical characteristics of the ink cartridge. Then, the printer 10 identifies the characteristic of the ink cartridge based on the mechanical characteristics of the key portion 78 of the ink cartridge.

The key portion 78 protrudes upward from the third upper surface 83. The key portion 78 has a front sloped surface 84B, an upper end surface 86, and a lock surface 87. The front sloped surface 84B is continuous with the rear end of the surface 82A. As the front sloped surface 84B extends rearward from the front end of the front sloped surface 84B, the front sloped surface 84B approaches toward the left. The upper end surface 86 is continuous with the rear end of the front sloped surface 84B.

Both the front sloped surface 84B and the upper end surface 86 are positioned further upward than the other portions of the key portion 78 other than both the front sloped surface 84B and the upper end surface 86. The upper end surface 86 is positioned at the upper end of the main body 31. The lock surface 87 is continuous with the rear end of the upper end surface 86. The contact surface 92 extends rearward from the lower end of the lock surface 87. The operation surface 68 is continuous with the rear end of the third upper surface 83.

The surface 81A, the surface 82A, the front sloped surface 84B, the upper end surface 86, and the contact surface 92 are positioned the uppermost of the protruding upper wall 44P in the left-right direction (i.e., when viewed in the left-right direction). In other words, the surface 81A, the surface 82A, the front sloped surface 84B, the upper end surface 86, and the contact surface 92 are positioned further upward than the other portions of the protruding upper wall 44P other than the surface 81A, the surface 82A, the front sloped surface 84B, the upper end surface 86, and the contact surface 92. As illustrated in FIG. 7A, the parting line 717 extends along the surface 81A, the surface 82A, the front sloped surface 84B, and the upper end surface 86.

As illustrated in FIG. 4, the bottom wall 45 includes a rear lower wall 45R and a front lower wall. The front lower wall is positioned at the front portion of the bottom wall 45, although covered by the cover 32 and thus not shown in FIG. 4. The rear lower wall 45R is positioned at the rear portion of the bottom wall 45. The supply portion 33 is positioned at the right portion of the rear lower wall 45R.

As illustrated in FIG. 7A, the sloped wall 716 is obliquely intersected with the left wall 42. In other words, the sloped wall 716 is obliquely connected to the left wall 42. As illustrated in FIG. 5, the sloped wall 716 includes the upper sloped wall 716T and the lower sloped wall 716B. The upper sloped wall 716T connects the front left wall 42F and the upper left wall 42T. The lower sloped wall 716B connects the front left wall 42F and the lower left wall 42B. The upper sloped wall 716T is positioned further upward than the lower sloped wall 716B. A sloped lib 718 is positioned between the upper sloped wall 716T and the lower sloped wall 716B.

The upper left wall 42T and the lower left wall 42B are examples of the first region. The front left wall 42F is an example of the second region. The upper right wall 43T and the lower right wall 43B are examples of the first region. The front right wall 43F is an example of the second region. As illustrated in FIG. 7A, the distance between the outer surface of the upper left wall 42T and the virtual surface 707, and the distance between the outer surface of the lower left wall 42B and the virtual surface 707 are defined as a third distance D3. The distance between the outer surface of the front left wall 42F and the virtual surface 707 is defined as a fourth distance D4. The third distance D3 is greater than the fourth distance D4.

The intersection angle between the upper sloped wall 716T and the upper front wall 40T is an obtuse angle. The intersection angle between the upper sloped wall 716T and the upper left wall 42T is an obtuse angle. The intersection angle between the lower sloped wall 716B and the lower front wall 40B is an obtuse angle. The intersection angle between the lower sloped wall 716B and the lower left wall 42B is an obtuse angle.

As illustrated in FIGS. 3 and 4, each of the upper left wall 42T, the upper right wall 43T, the rear upper wall 44R, and the protruding upper wall 44P is continuous with the upper rear wall 41T. Each of the lower left wall 42B, the lower right wall 43B, the rear lower wall 45R is continuous with the lower rear wall 41B. Each of the front left wall 42F, the front right wall 43F, the front upper wall, and the front lower wall is continuous with the upper front wall 40T. Part of the storage chamber 46 is defined by the front left wall 42F, the front right wall 43F, the front upper wall, the front lower wall and the upper front wall 40T. In the left-right direction, the distance between the front left wall 42F and the front right wall 43F is shorter than the distance between the outer surface of the upper left wall 42T and the outer surface of the upper right wall 43T.

As illustrated in FIGS. 3 and 4, the main body 31 includes the left lib 702, the right lib 703, an upper lib 704, the rear lib 714, and the sloped lib 718. The left lib 702 and the right lib 703 are at positions in which the left lib 702 and the right lib 703 face each other in the left-right direction. In other words, the left lib 702 and the right lib 703 overlap each other in the left-right direction (i.e., when viewed in the left-right direction).

As illustrated in FIG. 3, the left lib 702 is positioned between the upper left wall 42T and the lower left wall 42B in the up-down direction. The left lib 702 extends linearly in the front-rear direction. The left lib 702 is recessed inward toward the inside of the storage chamber 46 on the left wall 42.

As illustrated in FIG. 4, the right lib 703 is positioned between the upper right wall 43T and the lower right wall 43B in the up-down direction. The right lib 703 extends linearly in the front-rear direction. The right lib 703 is recessed inward toward the inside of the storage chamber 46 on the right wall 43.

As illustrated in FIG. 3, the upper lib 704 is positioned between the central upper wall 44C and the rear upper wall 44R in the front-rear direction. The upper lib 704 extends linearly in the left-right direction. The upper lib 704 protrudes outward toward the outside of the storage chamber 46 on the upper wall 44.

As illustrated in FIG. 3, the rear lib 714 is positioned between the upper rear wall 41T and the lower rear wall 41B in the up-down direction. The rear lib 714 extends linearly in the left-right direction. The rear lib 714 is recessed inward toward the inside of the storage chamber 46 on the rear wall 41.

As illustrated in FIG. 5, the sloped lib 718 is positioned between the upper sloped wall 716T and the lower sloped wall 716B in the up-down direction. The sloped lib 718 extends linearly in both the left-right direction and the front-rear direction. The sloped lib 718 is recessed inward toward the inside of the storage chamber 46 on the sloped wall 716.

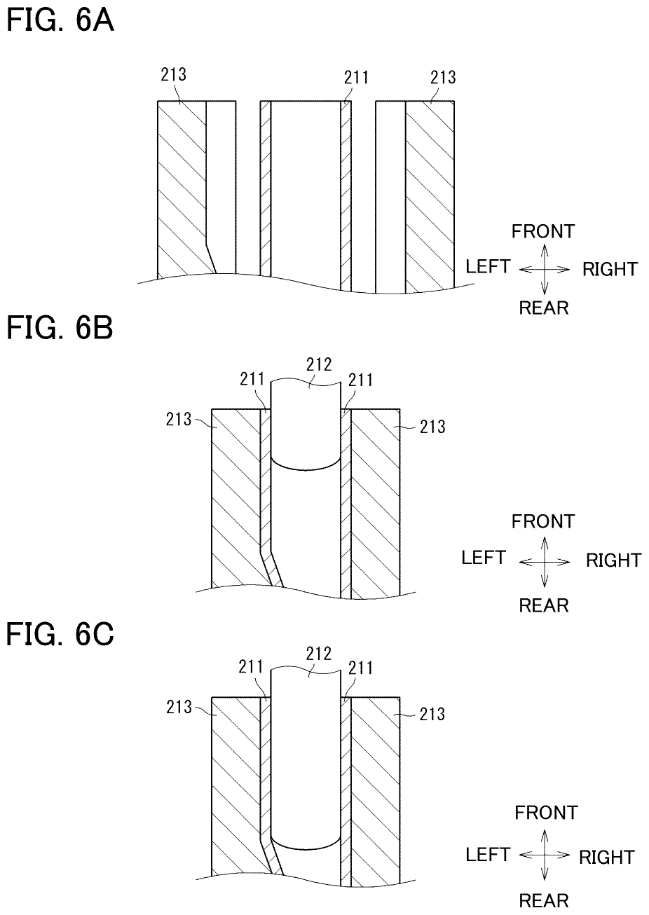

The main body 31 is formed as a single member by blow-molding. As shown in FIG. 6A, in blow-molding, a molten parison 211 having a cylindrical shape is supplied downward from a blow-molding machine. As illustrated in FIGS. 6B and 6C, the parison 211 is clamped by the molds 213 (or enclosed by the molds 213). Then, a blow pin 212 is inserted into the inside of the parison 211 in a state where the parison 211 is clamped by the molds 213 (or enclosed by the molds 213). Next, air is injected into the parison 211 from the blow pin 212. At this time, the upper end portion of the parison 211 is clamped (or held) between the outer surface of the blow pin 212 and the inner surfaces of the molds 213.

As a result, the supply portion 33 is blow-molded. The supply portion 33 has a transfer surface in which the shape of the outer peripheral surface of the blow pin 212 is transferred as part of the inner peripheral surface of the supply portion 33. Thereafter, the molds 213 are detached and the unnecessary portion of the parison 211 is removed (trimmed off) by punching.

In FIG. 7A, the distance between the virtual surface 707 and the left wall 42 in the left-right direction is defined as a first distance D1. The distance between the virtual surface 707 and the right wall 43 in the left-right direction is defined as a second distance D2. The first distance D1 is greater than the second distance D2. In other word, the main body 31 is asymmetrical with respect to the virtual surface 707.

As illustrated in FIG. 7A, the parting line 717 extends from the front end of the main body 31 to the rear end of the surface 82A of the upper wall 44 in the front-rear direction along the virtual surface 707 when viewed from above. At a portion further rearward than the rear end of the surface 82A, the parting line 717 extends from the front end of the front sloped surface 84B of the upper wall 44 to the rear end of the contact surface 92 through the upper end surface 86. At a portion further rearward than the rear end of the contact surface 92, the parting line 717 extends in the front-rear direction at the left-right center of the operation surface 68 along the virtual surface 707. As illustrated in FIG. 7B, the parting line 717 extends in the up-down direction along the virtual surface 707 at the rear wall 41.

### Effects of the First Embodiment

In a known ink cartridge, a first case member and a second case member which has a different shape from the first case member are separately formed by injection-molding. Then, the first case member and the second case member are joined together for manufacturing the known ink cartridge. On the other hand, in the first embodiment, the main body 31 which has the asymmetrical shape is formed by a single blow-molding. Accordingly, the number of steps and the costs of mold required to manufacture the ink cartridge 30 can be reduced.

The cartridge case 110 of the printer 10 is configured to fix the ink cartridge 30 in position through contacting the key portion 78. In a state where the ink cartridge 30 is fixed in position by the cartridge case 110, the cartridge case 110 detects the mechanical characteristic of the key portion 78. Therefore, it is necessary for the key portion 78 to have rigidity such that the key portion 78 does not deform even when contacted by the cartridge case 110. In the first embodiment, since the parting line 717 is positioned on the key portion 78, the thickness of the parison is greatest at the key portion 78. Accordingly, the rigidity of the key portion 78 can be secured.

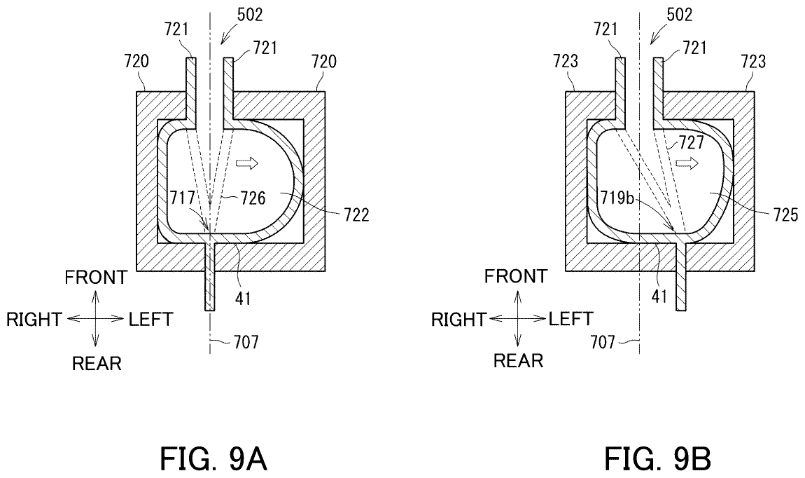

FIG. 9A is a top sectional view of the main body 31 during blow-molding of the main body 31. In the main body 31, the parting line 717 is positioned on the virtual surface 707 at the rear wall 41. A dashed line 726 in FIG. 9A indicates the position of a parison 721 immediately before the start of blow-molding. The main body 31 has a left space 722 larger than the left space 722 of the parison 721 immediately before the start of blow-molding. That is, the parison 721 is greatly stretched by blow-molding at the left space 722. Accordingly, the thickness of the portion of the parison 721 positioned at the left space 722 is thinner than the thickness of the other parts of the parison 721.

In the main body 31 of the first embodiment, the left space 722 is narrowed by the sloped wall 716 in such a manner that the front-left corner of the left space 722 is cut off. Accordingly, the stretch amount of the parison 721 (the amount of extension of the parison 721) is reduced. As a results, the likelihood of decreasing in the thickness of the parison 721 can be reduced.

In the main body 31, the stretch amount of the parison 721 is not uniform. For example, the thickness of a parison decreases at the corners of the mold as the parison extends into the depths of the corners. The degree of reduction in the thickness of the parison becomes more apparent as the corner becomes more acute. In a case where the sloped wall 716 is disposed at the corner of the mold, the corner of the mold becomes an obtuse angle. In other words, in a case where the sloped wall 716 is disposed at the corner of the mold, the parison 721 does not extend into the depth of the corner. Accordingly, the likelihood of decreasing in the thickness of the parison 721 can be reduced.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiment of the disclosure, as set forth above, is intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

### Variation of the First Embodiment

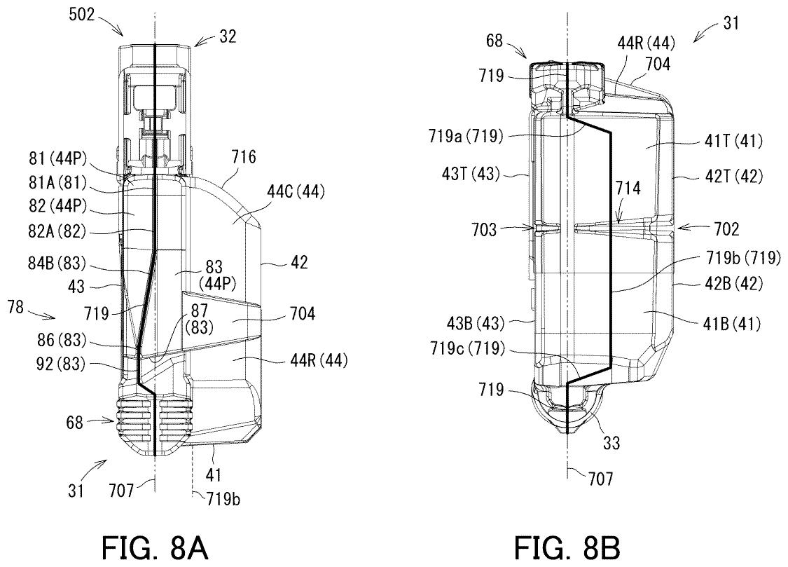

In the first embodiment, as illustrated in FIG. 7B, the parting line 717 extends in the up-down direction along the virtual surface 707 at the rear wall 41. However, in this variation, a second portion 719b of a parting line 719 may extend in the up-down direction at a position further leftward than the virtual surface 707 at the rear wall 41 as illustrated in FIG. 8B.

The parting line 719 has a first portion 719a, the second portion 719b, and a third portion 719c. At the upper portion of the rear wall 41, the first portion 719a obliquely extends in the rightward direction and the downward direction from the portion of the parting line 719 positioned on the virtual surface 707 when viewed from the rear. The first portion 719a is connected to the upper end of the second portion 719b. The second portion 719b extends in the up-down direction. At the lower portion of the rear wall 41, the third portion 719c obliquely extends in the rightward direction and the upward direction from the portion of the parting line 719 positioned on the virtual surface 707 when viewed from the rear. The third portion 719c is connected to the lower end of the second portion 719b. The parting line 719 overlaps the virtual surface 707 at the supply portion 33. Accordingly, the second portion 719b is positioned closer to the left wall 42 than the portion of the parting line 719 positioned at the supply portion 33 is to the left wall 42.

FIG. 9B is a top sectional view of the main body 31 in which the parting line 719 is positioned further leftward than the virtual surface 707 at the rear wall 41, during blow-molding of the main body 31. A dashed line 727 in FIG. 9B indicates the position of the parison 721 immediately before the start of blow-molding. The parison 721 in this variation which is indicated with the dashed line 727 in FIG. 9B is positioned further leftward than the parison 721 in the first embodiment which is indicated with the dashed line 726 in FIG. 9A. Hence, in this variation, a left space 725 of the parison 721 is smaller than the left space 722 of the parison 721 of the first embodiment. Accordingly, in the left space 725, the likelihood of the decreasing of the thickness of the parison 721 can be reduced in comparison to that in the left space 722 of the first embodiment.

In the first embodiment, the first distance D1 is greater than the second distance D2 in the main body 31. However, the present disclosure is not limited to this configuration of the first embodiment. For example, the second distance D2 may be greater than the first distance D1 in the main body 31. In examples other than the first embodiment, the left portion and the right portion may be reversed, and the effects of the present disclosure can still be obtained even when the left portion and the right portion are reversed.

### Second Embodiment

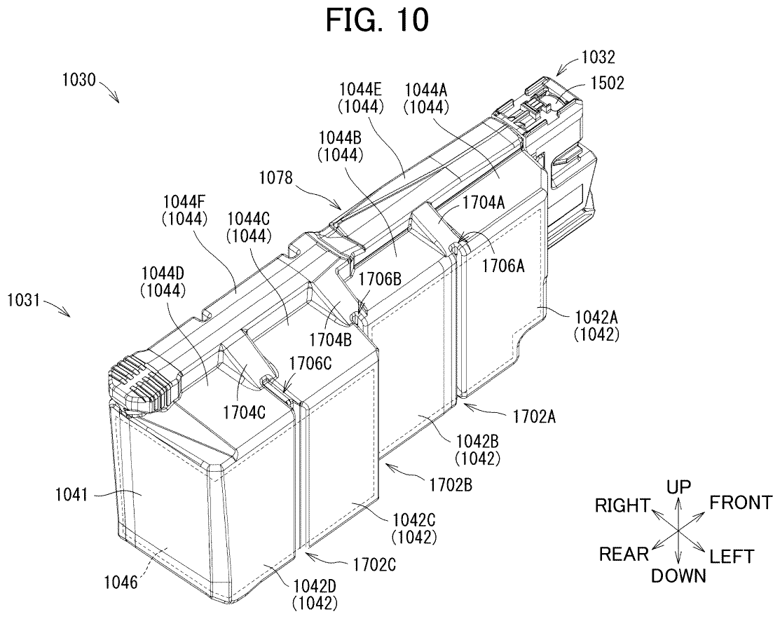

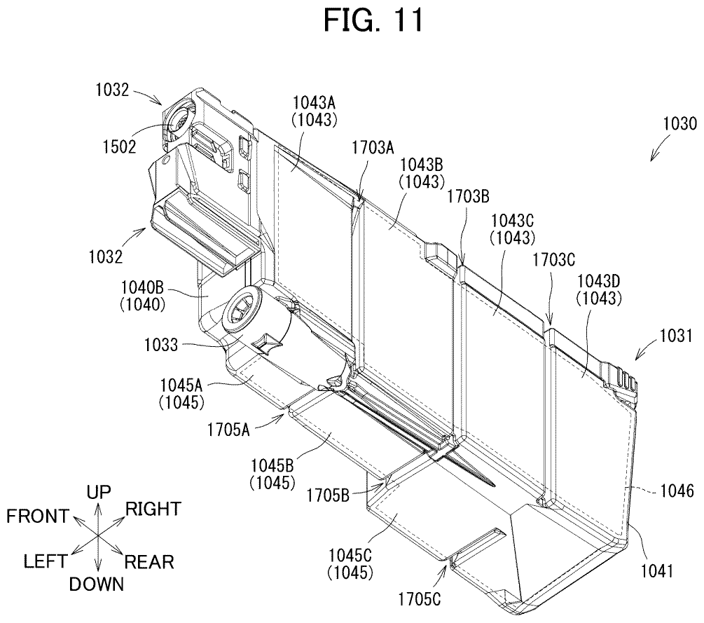

As illustrated in FIGS. 10 and 11, an ink cartridge 1030 includes a main body 1031 and a cover 1032. The main body 1031 includes a front wall 1040, a rear wall 1041, a left wall 1042, a right wall 1043, an upper wall 1044, a lower wall 1045, and a storage chamber 1046. The main body 1031 further has a supply portion 1033 and an atmospheric passage portion 1502.

As illustrated in FIG. 11, the front wall 1040 includes an upper front wall and a lower front wall 1040B. The upper front wall is positioned at the upper portion of the front wall 1040 although covered by the cover 1032 and thus not shown in FIG. 11. The upper front wall has the atmospheric passage portion 1502. The lower front wall 1040B is positioned further downward and rearward than the upper front wall. The lower front wall 1040B is continuous with the supply portion 1033.

As illustrated in FIG. 10, the left wall 1042 includes a first left wall 1042A, a second left wall 1042B, a third left wall 1042C, a fourth left wall 1042D which are arranged in this order from the front. The outer surface of the first left wall 1042A and the outer surface of the second left wall 1042B are flush with each other. The outer surface of the third left wall 1042C and the outer surface of the fourth left wall 1042D are flush with each other. Both the outer surface of the first left wall 1042A and the outer surface of the second left wall 1042B are positioned further rightward than both the outer surface of the third left wall 1042C and the outer surface of the fourth left wall 1042D.

A first left lib 1702A is positioned between the first left wall 1042A and the second left wall 1042B. A second left lib 1702B is positioned between the second left wall 1042B and the third left wall 1042C. A third left lib 1702C is positioned between the third left wall 1042C and the fourth left wall 1042D. The first left lib 1702A, the second left lib 1702B, and the third left lib 1702C are recessed rightward toward the inside of the storage chamber 1046 on the left wall 1042.

As illustrated in FIG. 11, the right wall 1043 includes a first right wall 1043A, a second right wall 1043B, a third right wall 1043C, and a fourth right wall 1043D which are arranged in this order from the front. The outer surfaces of the first right wall 1043A, the second right wall 1043B, the third right wall 1043C, and the fourth right wall 1043D are flush with each other.

A first right lib 1703A is positioned between the first right wall 1043A and the second right wall 1043B. A second right lib 1703B is positioned between the second right wall 1043B and the third right wall 1043C. A third right lib 1703C is positioned between the third right wall 1043C and the fourth right wall 1043D. The first right lib 1703A, the second right lib 1703B, and the third right lib 1703C are recessed leftward toward the inside of the storage chamber 1046 on the right wall 1043.

As illustrated in FIG. 10, the upper wall 1044 includes a first upper wall 1044A, a second upper wall 1044B, a third upper wall 1044C, and a fourth upper wall 1044D which are arranged in this order from the front and are positioned on the left portion of the upper wall 1044. The upper wall 1044 further includes a fifth upper wall 1044E and a sixth upper wall 1044F which are arranged in this order from the front and are positioned at the right portion of the upper wall 1044. The fifth upper wall 1044E includes a key portion 1078.

A first upper lib 1704A is positioned between the first upper wall 1044A and the second upper wall 1044B. A second upper lib 1704B is positioned between the second upper wall 1044B and the third upper wall 1044C. A third upper lib 1704C is positioned between the third upper wall 1044C and the fourth upper wall 1044D. The first upper lib 1704A, the second upper lib 1704B and third upper lib 1704C protrude upward toward the outside of the storage chamber 1046 at the upper wall 1044.

As illustrated in FIG. 11, the lower wall 1045 includes a first lower wall 1045A, a second lower wall 1045B, and a third lower wall 1045C which are arranged in this order from the front. A first lower lib 1705A is positioned between the first lower wall 1045A and the second lower wall 1045B. A second lower lib 1705B is positioned between the second lower wall 1045B and the third lower wall 1045C. A third lower lib 1705C is positioned in the third lower wall 1045C. The first lower lib 1705A, the second lower lib 1705B, and the third lower lib 1705C are recessed upward toward the inside of the storage chamber 1046 on the lower wall 1045.

As illustrated in FIGS. 10 and 11, the cover 1032 is mounted to the front portion of the main body 1031.

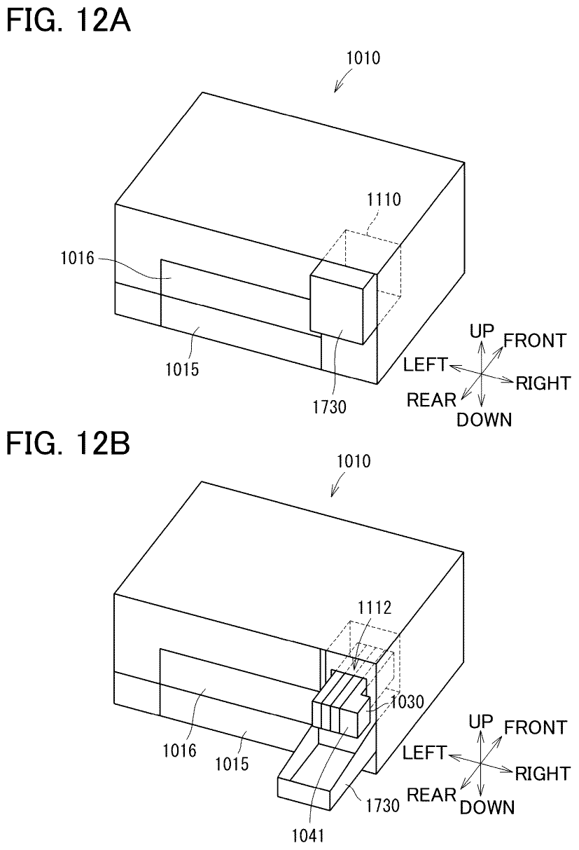

A printer 1010 to which the ink cartridge 1030 is attached is illustrated in FIGS. 12A and 12B. The printer 1010 includes a cartridge case 1110, a sheet feed tray 1015, a sheet discharge tray 1016, and a case cover 1730. The sheet feed tray 1015 and the sheet discharge tray 1016 are detachably attachable to the front portion of the printer 1010. The cartridge case 1110 has an opening 1112 at the front portion of the cartridge case 1110. The ink cartridge 1030 is detachably attachable to the cartridge case 1110.

The case cover 1730 is configured to open and close the opening 1112 of the cartridge case 1110. In a state where the case cover 1730 closes the opening 1112 of the cartridge case 1110, the front surface of the case cover 1730 is positioned further frontward than the front surfaces of the sheet feed tray 1015 and the sheet discharge tray 1016. In the front-rear direction, the rear wall 1041 of the ink cartridge 1030 is positioned between the front surface of the case cover 1730 and the front surfaces of the sheet feed tray 1015 and the sheet discharge tray 1016. The left wall 1042 of the ink cartridge 1030 is positioned further rightward than the right end of the opening 1112 of the cartridge case 1110 (i.e., the right end of the peripheral surface of the cartridge case 1110 defining the opening 1112).

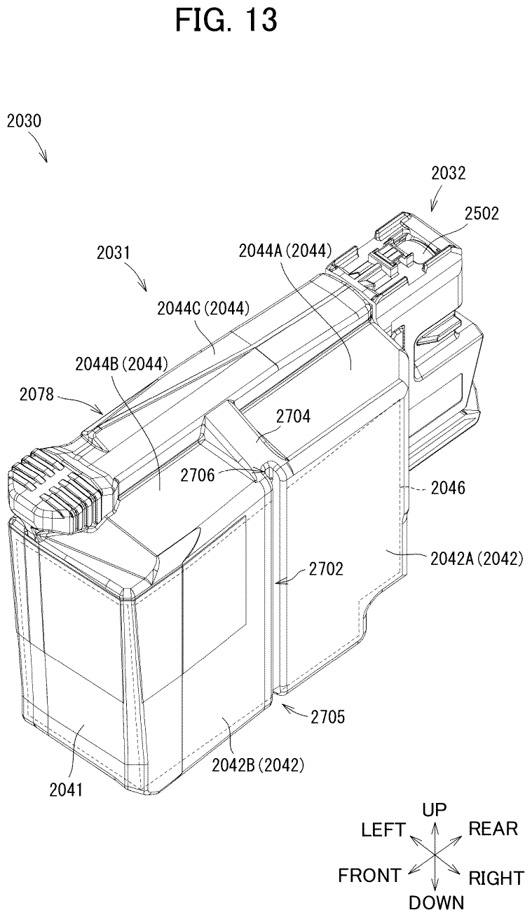

An ink cartridge 2030 which is different from the ink cartridge 1030 is illustrated in FIG. 13. The ink cartridge 2030 is detachably attachable to the cartridge case 1110. The ink cartridge 2030 includes a main body 2031 and a cover 2032. The main body 2031 includes a rear wall 2041, a left wall 2042, an upper wall 2044, a storage chamber 2046, and an atmospheric passage portion 2502. The ink cartridge 2030 also includes a front wall, a right wall, a lower wall, and a supply portion which are not shown in FIG. 13. The front wall faces the rear wall 2041 in the front-rear direction.

The right wall faces the left wall 2042 in the left-right direction. The lower wall faces the upper wall 2044 in the up-down direction.

As illustrated in FIG. 13, the left wall 2042 includes a first left wall 2042A and a second left wall 2042B which are arranged in this order from the front. The outer surface of the first left wall 2042A and the outer surface of the second left wall 2042B are flushed with each other. A left lib 2702 is positioned between the first left wall 2042A and the second left wall 2042B. The left lib 2702 is recessed rightward toward the inside of the storage chamber 2046 on the left wall 2042.

The upper wall 2044 includes a first upper wall 2044A and a second upper wall 2044B which are arranged in this order from the rear and are positioned at the right portion of the upper wall 2044. The upper wall 2044 also includes a third upper wall 2044C which is positioned at the left portion of the upper wall 2044. The third upper wall 2044C has a key portion 2078. In the front-rear direction, the position of the key portion 2078 of the ink cartridge 2030 and the position of the key portion 1078 of the ink cartridge 1030 are identical to each other.

An upper lib 2704 is positioned between the first upper wall 2044A and the second upper wall 2044B. The upper lib 2704 protrudes upward toward the outside of the storage chamber 2046 on the upper wall 2044. The cover 2032 is mounted to the front portion of the main body 31.

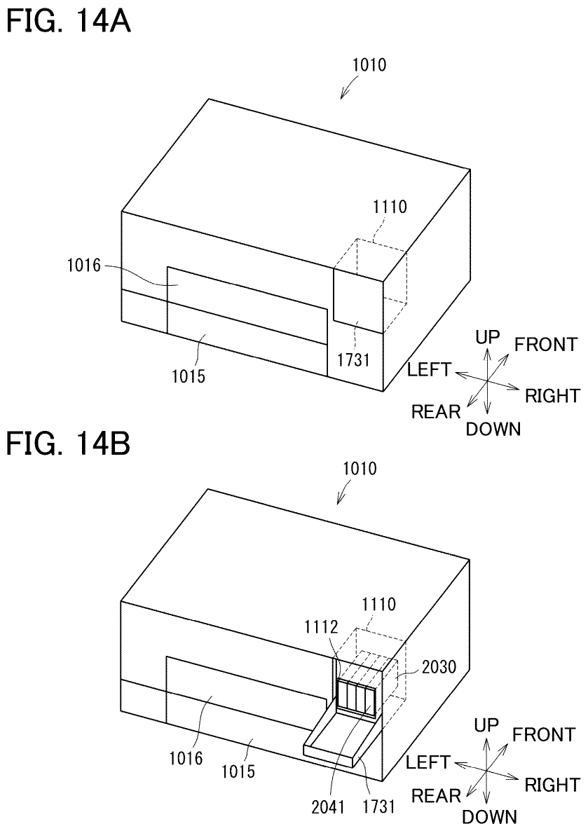

As illustrated in FIGS. 10 and 13, the ink cartridge 2030 in the front-rear direction is shorter than the ink cartridge 1030 in the front-rear direction. In the front-rear direction, the ink cartridge 2030 does not include portions corresponding to the third left wall 1042C and the fourth left wall 1042D of the ink cartridge 1030. As illustrated in FIG. 14, in a case where the ink cartridge 2030 is attached to the cartridge case 1110 instead of the ink cartridge 1030, a case cover 1731 is mounted to the printer 1010 instead of the case cover 1730. In other words, the case cover 1731 is employed in the printer 1010 instead of the case cover 1730. In a state where the ink cartridge 2030 is attached to the cartridge case 1110, the rear wall 2041 of the ink cartridge 2030 is positioned further frontward than the front surface of the printer 1010. In a state where the case cover 1731 closes the opening 1112 of the cartridge case 1110, the front surface of the case cover 1731 and the front surface of the printer 1010 are flush with each other.

The left wall 2042 of the ink cartridge 2030 is positioned further leftward than the right end of the opening 1112 (i.e., the right end of the peripheral surface the cartridge case 1110 defining the opening 1112). The ink cartridge 2030 is positioned inside the opening 1112 when viewed from the front. As such, the size of the rear portion of the ink cartridge 1030 in the rearward direction and the leftward direction is larger than the size of the rear portion of the ink cartridge 2030 in the rearward direction and the leftward direction.

### Effects of the Second Embodiment

In the printer 1010, the ink cartridge 1030 which has a capacity greater than the capacity of the ink cartridge 2030 can be attached to and detached from the printer 1010 through replacement of the case cover 1731 with the case cover 1730. Accordingly, the capacity of an ink cartridge can be increased inexpensively and easily (i.e., user can use an ink cartridge with an increased capacity inexpensively and easily).

What is claimed is:

1. A liquid container comprising:
a blow-molded housing having a parting line, the blow-molded housing including:
a first wall;
a second wall opposing the first wall in a left-right direction;
a liquid chamber positioned between the first wall and the second wall; and
a supply portion through which an inside of the liquid chamber is in communication with an outside of the liquid chamber,
wherein the parting line has a portion positioned at the supply portion, and
wherein a distance between the first wall and the portion of the parting line in the left-right direction is greater than a distance between the second wall and the portion of the parting line in the left-right direction.

2. The liquid container according to claim 1, further comprising:
a valve accommodated in the supply portion.

3. The liquid container according to claim 1,
wherein the blow-molded housing further includes:
an atmospheric passage portion through which the inside of the liquid chamber is in communication with the outside of the liquid chamber, the atmospheric passage portion being positioned further upward than the supply portion, and
wherein the parting line has a portion positioned at the atmospheric passage portion.

4. The liquid container according to claim 1,
wherein the blow-molded housing further includes:
a third wall positioned opposite the supply portion with respect to the liquid chamber in a front-rear direction,
wherein the parting line has:
a first portion positioned at an upper portion of the third wall;
a second portion connected to a lower end of the first portion; and
a third portion positioned at a lower portion of the third wall, the third portion being connected to a lower end of the second portion,
wherein the second portion is positioned closer to the first wall in the left-right direction than the portion of the parting line is to the first wall in the left-right direction,
wherein the first portion extends to the second portion from a position closer to the second wall than the second portion is to the second wall in the left-right direction, and
wherein the third portion extends to the second portion from a position closer to the second wall than the second portion is to the second wall in the left-right direction.

5. The liquid container according to claim 1, further comprising:
a lock portion configured to engage with a cartridge attachment portion of an image forming apparatus, the lock portion being positioned closer to the second wall than the portion of the parting line is to the second wall in the left-right direction, and
wherein the parting line has a portion positioned at the lock portion.

6. The liquid container according to claim 1,
wherein the first wall has a first region and a second region,
wherein a distance between the first region and the portion of the parting line in the left-right direction is greater than a distance between the second region and the portion of the parting line in the left-right direction.

7. The liquid container according to claim 6,
wherein the first region is positioned further rearward than both the supply portion and the second region.

8. The liquid container according to claim 1,
wherein the housing further includes a sloped wall obliquely intersected to the first wall, the sloped wall being positioned between the first wall and the supply portion.

9. The liquid container according to claim 1,
wherein the first wall is a left wall of the housing and the second wall is a right wall of the housing.

10. The liquid container according to claim 1,
wherein the first wall is a right wall of the housing and the second wall is a left wall of the housing.

11. The liquid container according to claim 4,
wherein the third wall is a rear wall of the housing.

12. The liquid container according to claim 1,
wherein the blow-molded housing further includes:
a third wall positioned opposite the supply portion with respect to the liquid chamber in a front-rear direction,
wherein the parting line has:
a middle portion positioned closer to the first wall than the portion of the parting line is to the first wall in the left-right direction, the middle portion extending in an up-down direction to have an upper end and a lower end;
an upper portion positioned at an upper part of the third wall, the upper portion extending obliquely upward from the upper end of the middle portion toward the second wall; and
a lower portion positioned at a lower part of the third wall, the lower portion extending obliquely downward from the lower end of the middle portion toward the second wall.
